(19) United States
(12) Patent Application Publication
(10) Pub. No.: US 2018/0130142 A1
(43) Pub. Date: May 10, 2018

(54) Garco Energy Saver

(71) Applicant: Israel Garza, Cincinnati, OH (US)

(72) Inventor: Israel Garza, Cincinnati, OH (US)

(21) Appl. No.: 15/344,683

(22) Filed: Nov. 7, 2016

(51) Int. Cl. G06Q 50/06; G06Q 20/14; G06Q 20/34

(52) U.S. Cl. CPC G06Q 50/06; G06Q 20/34; G06Q 20/14

(57) ABSTRACT

An method for monitoring electrical power consumption including a transmitter for transmitting an information relating to a number of consumed electrical power units from an electrical power meter to a receiver and receiving unit receives the signals transmitted by electrical power meter and processed signal to generate a cost of electrical power consumption and consequently displayed the cost of electrical power consumption and said number of consumed electrical power units on the display unit. The data relating to cost of electrical power consumption and number of consumed electrical power units is archived in a storage module with a time stamp. The user can provide an input via a user input device for retrieving the stored data relating to cost of electrical power consumption and number of consumed electrical power units. The retrieved data being displayed graphically on display units. The electrical power consumption contains billing amount in real-time.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

### (1) Field of Invention

The present invention generally relates to an electrical power consumption monitoring system. More particularly, the present invention relates to an electrical power consumption monitoring system which monitors electrical power consumption, converts it into a constant, readily available visual display of energy consumption in dollars and cents, provides data for electrical power consumption during past time periods for consumer's review and allow consumer to make payment of utility bills”.

### (2) Background of Invention

With introduction of electrical devices for different tasks, the energy demand has been on increase around the world. Increased electrical power consumption has also generated heightened concerns for environment. There is a need to conserve energy to protect environment as well as to be able to use the saved energy for other necessary energy requirements. Besides these advantages, the energy conservation is also directly beneficial for a consumer as it helps in saving money by reducing their utility bill. Consumers try different methods to save energy and associated cost. For example, they install special devices such as thermostat in their premises which monitor the load conditions and then cut power supply to certain devices during peak loading conditions. With help of these and other measures the consumer is able to reduce some electrical power consumption and thus save money. A user may also monitor the power consumption by monitoring the electrical power meter which displays the electric power consumed by one or more appliances connected to the electrical circuit which is under monitoring by the electrical power meter. However, it is difficult for a user to identify the electrical power consumed in real time from some ambiguous reading from an electrical power meter. Hence there is a need for a system which can provide real time electrical power consumption data. Some devices have been developed to assist a user in monitoring the electrical power consumption. For example, U.S. Pat. No. 4,630,211 A issued to Pettis Charles D on 1986, Dec. 16, discloses a portable display unit which displays current cost and current cost per hour of the energy consumed. Similarly, U.S. Pat. No. 5,287,287 A issued to Energy Audit Corporation on 1994, Feb. 15, discloses a device for displaying power consumption rates as cost per kilowatt-hour as assessed by local power company. However, these systems and methods of monitoring electrical power consumption do not help efficiently in creating awareness amongst the consumers about the real time cost of the electrical power consumption. If consumers are aware on a daily, hourly basis of how much electrical power they are consuming, and how much the electrical power consumption is costing them in real dollars, not some ambiguous meter reading that is located in a not so easy to see location, they would be more apt to conserve energy. When the consumer see the electric bill ticking upwards penny by penny, dollar by dollar, it gives you incentive to turn off lights in the daytime, by some window insulation, adjust the thermostat, etc. Further, it is desired that the system should provide the data for electrical power consumption during past time periods by the consumer for easy review and planning. It is yet further desirable that the system should allow submitting electrical utility bills for providing convenience to the consumer. It is further desirable that mobile devices can communicate with the system for providing a convenient way use of using the system.

It is an aspect of the invention to overcome or alleviate a problem of the prior art.

This permits the use of the present invention which enhance the prior art of the monitoring systems for providing record of the past electrical power consumption, real time energy power consumption in energy units as well as currency and allowing utility bill submission for achieving efficient reduction in electrical power consumption and associated cost for a customer.

### BRIEF SUMMARY OF THE INVENTION

In view of the foregoing, one aspect of the various disclosed embodiments in the present invention is to provide an electrical power consumption monitoring system and a computer program for communicating with the electrical power consumption monitoring system from a mobile device.

Preferably the electrical power consumption monitoring system and the computer program address, or at least ameliorate one or more of the problems described above. To this end, the present invention related to an electrical power consumption monitoring system and a computer program, with some unique aspects is disclosed.

Accordingly, it is a primary object of the present invention to provide an electrical power consumption monitoring system which monitors electrical power consumption and converts it into a constant, readily available visual display of energy consumption in dollars and cents. The purpose of the electrical power consumption monitoring system is energy consumption awareness so as to promote energy conservation as well as reduction in cost of electrical power in utility bills. The electrical power consumption monitoring system includes a transmitter, receiver, an internal circuitry and display monitor where the transmitter takes reading from an electrical power meter and sends the signal to the receiver which in turn sends the signal to internal circuitry for conversion of the signal into cost of electrical power consumption in currency. The display monitor shows the current electrical power consumption in energy units such as kilowatt-hours as well as cost of electrical power consumption in currency to the user.

It is another object of the present invention that the electrical power consumption monitoring system stores data for electrical power consumption during past time periods and display it for consumer's review.

It is yet another object of the present invention that the electrical power consumption monitoring system sends alert over phone to a preset currency amount. Every time the energy equivalent to preset currency amount is consumed, the user would get an alert on phone.

It is yet another object of the present invention that the electrical power consumption monitoring system includes a card scanner to allow payment of utility bills.

It is still another object of the present invention to provide a computer program which can be downloaded and installed on a mobile device such as cell phone, computer, laptop to communicate with the electrical power consumption monitoring system.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a sketch of an electrical power consumption monitoring system.

FIG. 2 shows a perspective view of an electrical power consumption monitoring system.

FIG. 3 shows a primary screen displaying energy usage of a particular billing month.

FIG. 4 shows a graph screen that allows a user to monitor energy consumption through detailed graph.

FIG. 5 shows a report screen that allows the user to send reports to the electricity company.

FIG. 6 shows an archive screen that allows a user to quickly check past energy usage.

### DETAIL DESCRIPTION OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

Embodiments of the present invention provide an electrical power consumption monitoring system for helping a user to conveniently monitor electrical power consumption in real time, refer to electrical consumption data for past time periods and make payment of utility bills. Accordingly, the specific embodiments discussed herein are merely illustrative of specific manners in which to make and use this invention, and are not intended to represent an exhaustive list of all possible structure and processes of the present invention.

Embodiments of the system and method of using it are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

Aspects of the present inventive subject matter are described with reference to the figures provided herein.

The present invention provides an electrical power consumption monitoring system which takes signals from an electrical power meter and provides information to the consumer for increasing awareness about the real time electrical power consumption and promoting reduction in power consumption. The electrical power consumption monitoring system includes a transmitter, a receiver, internal circuitry that includes a processor, a display monitor, a keypad and a card scanner. A housing is provided which stores the receiver, display monitor, keypad and internal circuitry. The electrical power consumption monitoring system is connected to an electrical power meter by the transmitter. The transmitter can be connected to the electrical power meter by a hardwire connection or by a wireless connection. The transmitter takes readings from the read out gauge of the electrical power meter in form of signals and transfers them to the receiver. The receiver picks up the signal from the transmitter wirelessly or by hardwire. The signals transferred by the transmitter to the receiver include the electrical power consumption data. The wireless signal transmitter may be a wireless modem. The transmitter is also connected to a power source by a hardwire connection, where the power source provides the transmitter with power for the operation of the transmitter. Similarly, the housing has a hardwire connection for operating power source to supply power for operation of receiver, display monitor, keypad and internal circuitry.

The receiver sends the signal received from the transmitter to the internal circuitry for processing and storage. The signal received from the receiver includes the electrical power consumption data received from the electrical power meter read out gauge. The internal circuitry is programmed with a mathematical computation to convert the electrical power consumed in KW hours to the cost in applicable currency (for example, dollars and cents), by using the applicable billing rate already fed by user in the internal circuitry, and the electrical power consumption data received from the electrical power meter read out gauge as input for the mathematical computation. The internal circuitry has a memory which stores the signals received from the transmitter in form of electrical power consumed in energy units such as kilowatt-hours and also stores the cost of electrical power consumed.

The memory thus generates an archive of electrical power consumed and cost of electrical power consumption in currency during past time periods in the form of daily, weekly and monthly electrical power consumption. The memory may be a memory card or memory board. The internal circuitry handles all conversions and send output to the apportioned sites i.e. display monitor, archives, wireless feed, etc. After completing the mathematical computation, the internal circuitry sends out the cost of electrical power consumed in real time to the display monitor. The electrical power consumption monitoring system also sends alert over phone for a preset currency amount. The user may set the currency amount in the internal circuit which stored this information it its memory. Every time the energy equivalent to preset currency amount is consumed, the user would get an alert on phone. For example, if a user set $10.00 or $20.00 as the amount for alert generation, he/she would get an alert for every $10.00 or $20.00 spent on energy consumption. The electrical power consumption monitoring system sends the alert to the phone using wireless connection.

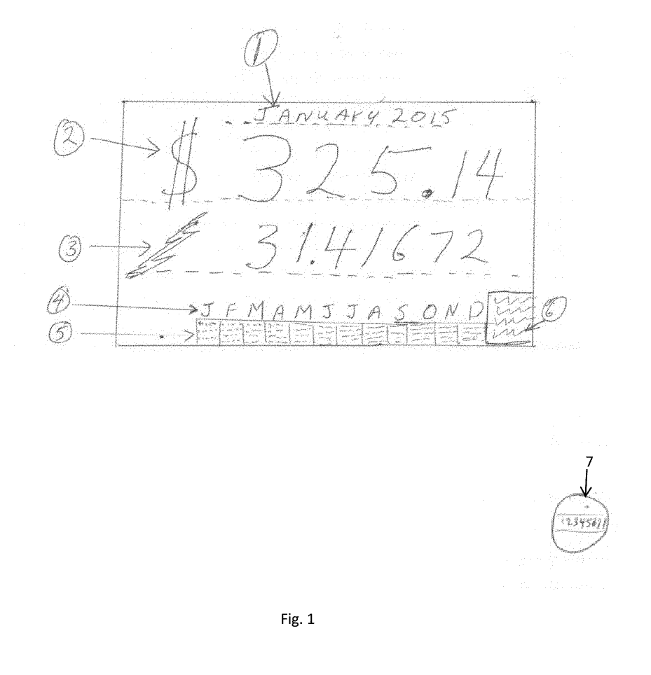

The display monitor shows the digital read-out of both energy-related and corresponding monetary-related information to the consumer. Referring to FIG. 1, an exemplary representation of the electrical power consumption monitoring system in connection with a display monitor is shown. The display monitor of the electrical power consumption monitoring system includes a processor, and receives as well as displays a signal that is sent by a transmitter (not shown) from an electrical power meter 7 on its screen as the real time electrical power consumed 3 in energy units such as kilowatt-hours (kWh). The display monitor also displays a signal received from the memory 2 as the cost of the electrical power consumed in currency such as dollars and cents on its screen. The display monitor shows the current month and year 4 on its screen for reference. The display monitor also shows the electrical power consumed 3 and cost of electrical power consumption 2 in currency during past time periods in the form of daily, weekly and monthly electrical power consumption for reference. The present date 1 along with month and year is displayed on the top of the device.

A keyboard 4 of the electrical power consumption monitoring system is connected to the internal circuitry for data input and data retrieval. The keyboard 4 is a standard digital keyboard including numbers and alphabets for inputting data. The keyboard 4 may preferably be enabled on the monitor display as a touch screen which provides keys for data input and data retrieval. The keyboard 4 provides twelve keys that represent every month of the year. A simple touch of a key corresponding to a particular month displays power consumption in both kilowatt-hours and dollars and cents for that month on the screen of the monitor display, which can be broken down to weeks or even power consumption for a particular day 5. The keyboard 4 allows search for the calendar archive on previous energy use. For this, the keyboard allows a user to retrieve information archived in the memory card such as daily consumption, weekly consumption, monthly consumption or peak consumption for comparisons. The keyboard also allows a user to enter the billing rate for the electrical power consumption into the internal circuitry. The billing rate is defined by a local power company and may vary for different power companies. An electric meter 7, as shown in FIG. 1, is communicatively coupled to the display monitor of the electrical power consumption monitoring system. The coupling can be hardwired or wireless. The electrical power meter includes a wireless modem to establish communication with remote units. The communication can be established on any communicating device such as a cellular phone, computers etc. and notifications generated and triggered to user communicating devices whenever the electricity consumption surpasses a predefined limit. All the data related to energy consumption and cost gets archived in a storage module 6. The storage module 6 is removably attached to the device to store and retrieve the historical data at any instant of time.

In one embodiment of the invention reset switches can also be provided to set or reset the amount of energy consumption in electric meter. A manual reset switch can be pressed at any time to nullify the readings on the other hand an auto reset switch can be programmed to nullify the readings at a predefined time interval. It can be programmed on daily, weekly or monthly basis depending on the user requirements. The electrical power consumption monitoring system can be turned on or off by using an ON/OFF switch.

In one other embodiment of the invention the electrical power consumption monitoring system also allows payment of utility bills. The card scanner of the electrical power consumption monitoring system is connected to cell phone, computer or landline and reads cards having data stored on a magnetic stripe incorporated into the card. The card scanner is known in the art to have a read head for passing a magnetic stripe of a card by to sense the data stored in the magnetic stripe to enable a money transaction. The keyboard of the electrical power consumption monitoring system allows entry of specific data such as passwords for bill payments. The money transaction for payment of utility bills is thus easily enabled by the card scanner of the electrical power consumption monitoring system. The cards used may be but not limited to credit cards and debit cards.

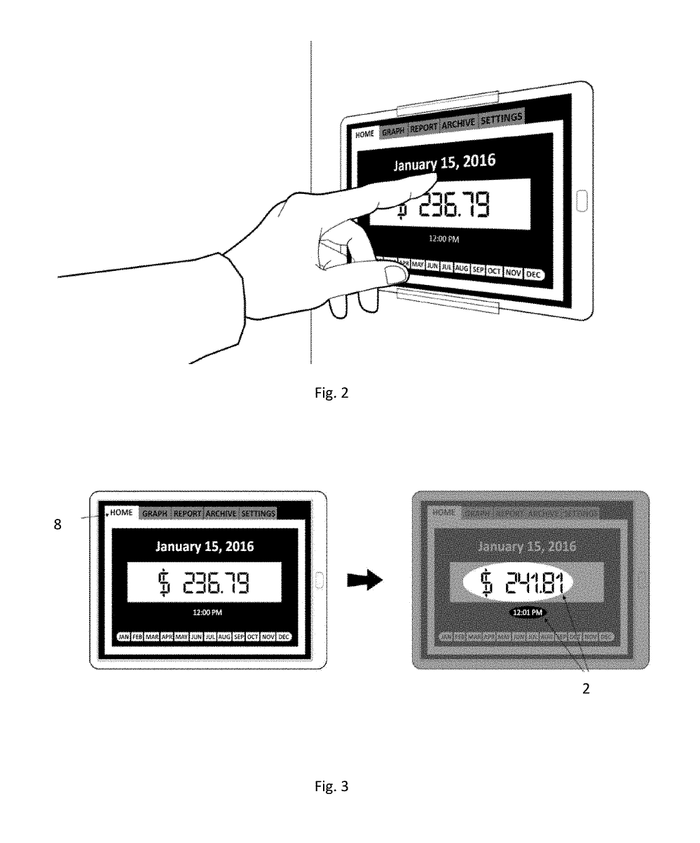

Referring to FIG. 2 shows a perspective view of an electrical power consumption monitoring system. The user can operate the device using a touch operated interface. The display device can constitute a display of any type and multiple keys can be provided for performing various operations as shown in figure.

FIG. 3 shows a home screen by pressing a home button 8 on the device interface, displaying energy usage of a particular billing month. In this mode the energy usage in KWH (kilo watt hour) or in the form of standard unit is displayed to user that is in easily human understandable form. The number of units shows a variation in real time and the user can track their electricity consumption in real time and can manage resources accordingly. For monitoring the load of particular machinery in household or commercial purposes all other devices or machineries are removed from the circuitry by bypassing those devices and running the single unit yields the energy consumption. The energy consumption is displayed against time and gets stored in the storage media in the same manner.

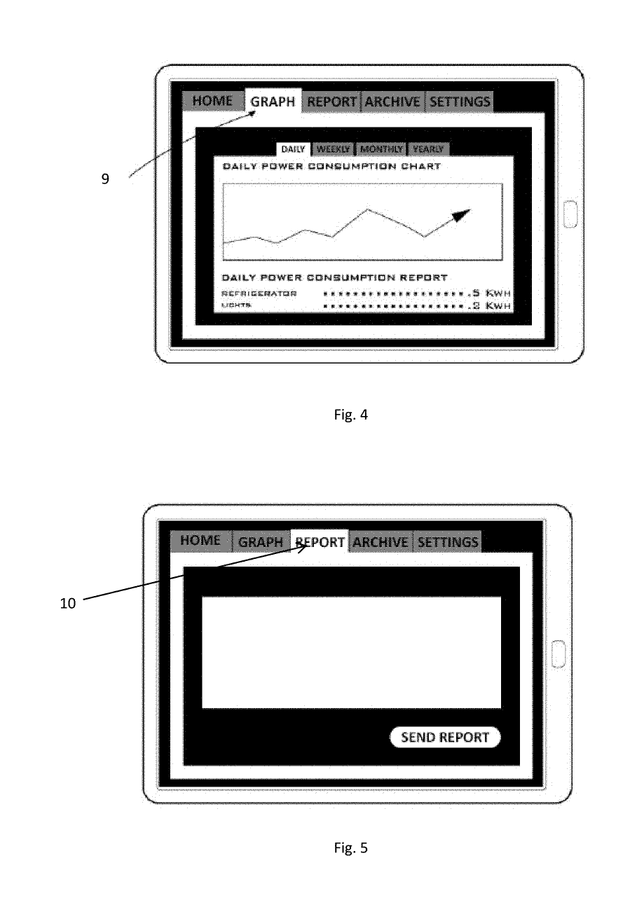

FIG. 4 shows a graph screen by pressing a graph button 9 that allows a user to monitor energy consumption through detailed graph. The graphs show a detailed and quick analysis of the variation of various parameters belonging to monitoring of electrical power consumption. These graphs can be customized to daily, weekly, monthly or yearly time durations by selecting the relevant options. These graphs majorly shows the variation of either a number of consumed electrical power units or a cost of electrical power consumption on one axis with time on the other axis.

FIG. 5 shows a report screen by pressing a report button 10 that allows the user to send reports to the electricity company. By using this option the users can easily send the reports to the electricity companies by means of communication channel. The reports can be either automatically generated or can be generated manually on the basis of exhausted parameters. The report regarding complaint against faulty operations or to correct minor/major faults can be transmitted with the location information.

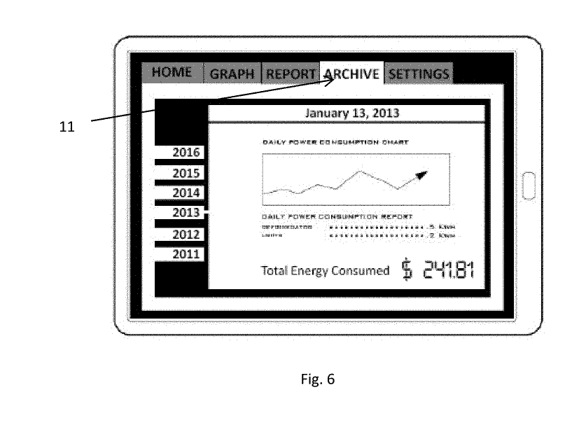

FIG. 6 shows an archive screen by pressing an archive button 11 that allows a user to quickly check past energy usage. The figure discloses a list of historical data stored year-wise in the storage module. The user can select this option by pressing an archive button provided on the top of the menu icon and the new interface discloses all the previously stored data to be retrieved by the user. The user can easily compare historical energy consumption data with the current data to understand the variations to curb their electricity expenses. In addition to this the device also discloses total energy consumed in the electric meter so far from the installation.

One more icon is provided under the name of settings that are provided for user to customize the interface by selecting their own preferences.

The electrical power consumption monitoring system of the present invention can be connected to a mobile device including but not limited to phones and computer systems, with help of a computer program. The electrical power consumption monitoring system has Wi-Fi connectivity to connect to the mobile device having the computer installed in it. The computer program can be downloaded and installed on phones, computers, laptops, tablets and other mobile computing devices. The computer program is programmed to allow installing rate changes for the power consumption to the electrical power consumption monitoring system. The computer program is further programmed to provide another means of retrieving information while away from the home and display the retrieved information to the consumer. The retrieved information includes data for electrical power consumption for past time periods and cost of electrical power consumption for past time periods stored in the memory of the electrical power consumption monitoring system. The computer program may be a phone app. In a preferred embodiment of the present invention, the electrical power consumption monitoring system supports e-payment system.

The electrical power consumption monitoring system of the present invention can be provided with multiple monitor displays where each of the multiple monitor display can be installed in different rooms to increase awareness about the cost of the electrical power consumed in real time. These multiple monitor displays are connected wirelessly or via hardwired data connection lines to a single processor which transmits the data about the electrical power consumption in real time and corresponding real time cost to each of the multiple monitor displays. If there are multiple electrical power meters in a premise, each of these multiple electrical power meters are connected to separate electrical power consumption monitoring system which work dedicatedly for their electrical power meter.

In yet another embodiment of the invention the electrical power monitoring system may be fastened to a wall, using for example but not limited to a wire, a hangar or a wall mount.

In yet another embodiment of the invention the step of receiving a user input includes any input selected from a group of home button, graph select button, report button, archive button and settings button.

In another embodiment of the invention the receiver comprises a communication device capable of transmitting and receiving signals. The communication devices selected from the group of cellular phone, laptop, palmtop, PDA, computers, mobile data devices capable of receiving and transmitting RF signals and combination thereof.

In another embodiment of the invention the electrical power consumption provides billing amount in real-time.

The electrical power consumption monitoring system of the present invention can be directly employed by the consumer or can be offered to the consumer by the power company. The power company can monitor the operation of the electrical power consumption monitoring system for providing a real-time electrical power consumption and dollar conversion for cost of the consumed electrical power in real time. The power company can also provide technical assistance for operation of the electrical power consumption monitoring system if needed. In the electrical power consumption monitoring system supplied and serviced by a power company, the electrical power consumption monitoring system downloads and shows monthly power bill generated by the power company.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the figures of the drawings, it should be understood that other and further modifications, apart from those shown or suggested herein, may be made within the spirit and scope of this invention.

What is claimed is:

1. An method for monitoring an electrical power consumption, comprises:
transmitting a signal from an electrical power meter via a transmitter to a processor, wherein said signal provides a number of consumed electrical power units;
receiving at said processor, via a receiver, said signal transmitted by said electrical power meter;
processing said signal to generate a cost of electrical power consumption;
displaying said cost of electrical power consumption and said number of consumed electrical power units on a display unit;
archiving said cost of electrical power consumption and said number of consumed electrical power units in a storage module in a predefined interval of time, wherein said storage module is communicatively coupled to said receiver;
receiving a user input via a user input device for retrieving said cost of electrical power consumption and said number of consumed electrical power units; and
displaying said cost of electrical power consumption and said number of consumed electrical power units on said display unit in a graphical manner.

2. The method as claimed in claim 1, wherein said step of transmitting said signal from said electrical power meter to said processor includes at least one wireless or hardwired connection.

3. The method as claimed in claim 1, wherein said step of receiving said signal includes said receiver capturing at least one said signal generated by said transmitter.

4. The method as claimed in claim 1, wherein said step of processing said signal includes a set of rules to calculate said cost of electrical power consumption from said signal received at said processor via said receiver.

5. The method as claimed in claim 1, wherein said step of archiving includes accumulating said cost of electrical power consumption and said number of consumed electrical power units in a non-volatile memory.

6. The method as claimed in claim 1, wherein said predefined interval of time selected from the group of past time periods in the form of hourly, daily, weekly, monthly and combination thereof.

7. The method as claimed in claim 1, wherein said displaying includes variation of said cost of electrical power consumption and said number of consumed electrical power units with time.

8. The method as claimed in claim 1, wherein said cost of electrical power consumption is calculated by the product of billing rate of an electrical power unit with said number of consumed electrical power units

9. The method as claimed in claim 1, wherein said electrical power meter includes a wireless modem as said transmitter for establishing communication with said processor via said receiver.

10. The method as claimed in claim 1, wherein said display unit is touch sensitive.

11. The method as claimed in claim 1, wherein said display contains at least one user input device.

12. The method as claimed in claim 11, wherein said user input device contains a user input means selected from a keyboard, microphone and combination thereof.

13. The method as claimed in claim 12, wherein said user input means is provided a plurality of keys to select a particular time duration selected from the group of a month, week, day, hour and combination thereof.

14. The method as claimed in claim 12, wherein said user input means allows said user to enter said billing rate.

15. The system as claimed in claim 1, wherein said receiver includes a communication device.

16. The method as claimed in claim 15, wherein said communication device includes electronic device selected from the group of cellular phone, laptop, palmtop, PDA, computers, mobile data devices capable of receiving and transmitting RF signals and combination thereof.

17. The method as claimed in claim 15, wherein said monitoring system communicates an alert to said communication device when said number of consumed electrical power units surpasses a limiting value.

18. The method as claimed in claim 1, wherein said display unit comprises a plurality of display monitors, and said processor is connected to said plurality of display monitors.

19. The method as claimed in claim 1, wherein a card scanner is connected to said receiver for allowing a user to make billing payments.

20. The method as claimed in claim 15, wherein a card scanner is connected to said communication device for allowing a user to make billing payments.

21. An system for monitoring electrical power consumption, comprises:
a processor;
a receiver, wherein said receiver is coupled to said processor and communicates with at least one electrical power meter;
a memory coupled to said processor and said receiver, wherein said memory includes a storage module for storing electrical power consumption information as well as the cost information associated with the electrical power that is consumed;
a display unit coupled to said processor and said memory; and
at least one user input device coupled to said memory and said display unit;
wherein said memory contains a set of programmable instructions that perform the steps of transmitting a signal from said electrical power meter to said receiver, wherein said signal provides a number of consumed electrical power units; said processor receives said signal transmitted by said electrical power meter form said receiver, and processes said signal to generate a cost of electrical power consumption; displaying said cost of electrical power consumption and said number of consumed electrical power units on said display unit; archiving said cost of electrical power consumption and said number of consumed electrical power units in said storage module of said memory that correspond to a desired predefined interval of time; and wherein said storage module is communicatively coupled to said receiver, such that said storage module receives a user input via said at least one user input device that retrieves said cost of electrical power consumption and said number of consumed electrical power units that correspond to said desired predefined interval of time; and displaying graphically said cost of electrical power consumption and said number of consumed electrical power units on said display unit.

22. The system as claimed in claim 21, wherein said cost of electrical power consumption is calculated by the product of a billing rate of an electrical power unit with said number of consumed electrical power units.

23. The system as claimed in claim 21, wherein said electrical power meter includes a wireless modem for transmitting said signal from said electrical power meter to said receiver.

24. The system as claimed in claim 21, wherein said display unit is touch sensitive.

25. The system as claimed in claim 21, wherein said user input device contains a user input means selected from at least one button, a keyboard, microphone, or a combination thereof.

26. The system as claimed in claim 25, wherein said user input means is provided a plurality of keys to select a particular time duration selected from the group of a month, week, day, hour and combination thereof.

27. The system as claimed in claim 25, wherein said user input means allows a user to enter said billing rate.

28. The system as claimed in claim 21, wherein said predefined interval of time selected from the group of past time periods in the form of hourly, daily, weekly, monthly and combination thereof.

29. The system as claimed in claim 21, wherein said receiver comprises a communication device.

30. The system as claimed in claim 29, wherein said communication device includes electronic device selected from the group of cellular phone, laptop, palmtop, PDA, computers, mobile data devices capable of receiving and transmitting RF signals and combination thereof.

31. The system as claimed in claim 29, wherein said monitoring system communicates alert to said communication device when said number of consumed electrical power units surpasses a limiting value.

32. The system as claimed in claim 21, wherein a card scanner is connected to said receiver for allowing a user to make billing payments.

33. The system as claimed in claim 29, wherein a card scanner is connected to said communication device for allowing a user to make billing payments.

34. The system as claimed in claim 21, wherein said display unit comprises a plurality of display monitors, and said processor is connected to said plurality of display monitors.
